(19) United States
(12) Patent Application Publication
(10) Pub. No.: US 2008/0149541 A1
(43) Pub. Date: Jun. 26, 2008

(54) APPARATUS, SYSTEM, AND METHOD FOR DETECTING AND REMOVING FLAWED CAPSULES

(76) Inventor: NICHOLAS D. BIGNEY, Wallsburg, UT (US)

Correspondence Address: Kunzler & McKenzie, 8 EAST BROADWAY, SUITE 600, SALT LAKE CITY, UT, 84111, US

(21) Appl. No.: 11/951,216

(22) Filed: Dec. 5, 2007

Related U.S. Application Data
(60) Provisional application No. 60/868,687, filed on Dec. 5, 2006.

(51) Int. Cl. B07C 5/34

(52) U.S. Cl. 209/597; 209/643

(57) ABSTRACT

An apparatus, system, and method for detecting flaws in capsules containing a beneficial agent include mechanisms for delivering the capsules to a top surface of a capsule receiving plate and moving the capsules into apertures in the plate. The apertures have structure that forms a passageway that narrows from an opening in the top surface to a location below the top surface. A minimum dimension of the passageway has a predetermined size and shape that is slightly larger than the capsules such that a flaw that has deformed the capsule causes the capsule to be inhibited from passing through the apertures. The structure may also include contact points or curves of intersection that engage the capsule and cause them to rotate. Mechanisms for removing the flawed capsules utilize one or more of brushes, inclined plane elements, gas plenums, and vacuums.

### CROSS-REFERENCES TO RELATED APPLICATIONS

This application is a claims priority to U.S. Provisional Patent Application No. 60/868,687 entitled “APPARATUS, SYSTEM, AND METHOD FOR DETECTING AND REMOVING FLAWED CAPSULES” and filed on Dec. 5, 2006 for Nicholas D. Bigney, which Provisional Patent Application is incorporated herein by reference.

### BACKGROUND OF THE INVENTION

1. Field of the Invention

This invention relates to devices and methods for processing capsules, and more particularly relates to a apparatuses and methods for detecting flaws in capsules.

2. Description of the Related Art

FIG. 1a is a perspective view diagram illustrating one embodiment of a two-piece capsule. The two-piece capsule (hereinafter “capsule”) 100 is generally formed of a first portion 102 and a second portion 104. The first portion 102 may have a diameter that is slightly larger than the diameter of the second portion 104 such that the first portion 102 is configured to securely receive the second portion 104. Once joined, the first and second portions 102, 104 are configured to maintain any beneficial agent contained there within.

The capsule 100 may be formed of a variety of different materials capable of being ingested. The materials include, but are not limited to, gelatin and vegetarian based materials. Capsules 100 have been a reliable drug delivery system for over one hundred years. Two-piece capsules are especially attractive because two piece capsules can be filled in-house, require a smaller equipment investment, and can be offered in a multitude of colors and print options. Additionally, two-piece capsules are easy to swallow, they mask odors and are tasteless.

The capsule 100 may be filled with liquid and/or solid beneficial agents. As used herein, the term “beneficial agent” refers to medicines and nutritional supplements. The process of filling a capsule 100 is well known to those skilled in the art. However, a brief description will be given here. A sealing machine works by filling the second portion 104 using an accurate volumetric pump. Once filled the sealing machine presses the first portion 102 onto the second portion 104. The second portion 104 may include a ring or bead (not shown) around the opening that functions to lock the first portion 102 in place.

FIG. 1b is a perspective view diagram illustrating one embodiment of a capsule 106 having a defect 108. Two-piece capsules may develop defects 108 during the filling process or during the process of closing the two portions, when the smaller portion closes by telescoping within the larger portion. Defects may include cracks (as depicted), bulges, indentations, occlusions, dimples, and other various flaws. These defects can make swallowing the capsule 106 difficult and even painful. Understandably manufacturers attempt to remove flawed capsules 106 from production runs. The primary method of removing flawed capsules 106 is by visual inspection.

Visual inspection may entail a process of inspecting and manipulating capsules 100 together with flawed capsules 106 as they pass on a conveyor belt at a speed selected to allow a person to detect and remove the flawed capsules 106. This, unfortunately, is not always effective.

### SUMMARY OF THE INVENTION

From the foregoing discussion, it should be apparent that a need exists for an apparatus, system, and method that more consistently and effectively detecting and removing flawed capsules. Advantageously, such an apparatus, system, and method will help avoid providing flawed capsules containing beneficial agents to users. One of the benefits is that individuals that take in the beneficial agent by swallowing the capsules will find doing so less difficult and less painful since the flawed capsules will have been removed.

The present invention has been developed in response to the present state of the art, and in particular, in response to the problems and needs in the art that have not yet been fully solved by currently available devices and methods. Accordingly, the present invention has been developed to provide an apparatus, system, and method for detecting flaws in capsules that overcome many or all of the above-discussed shortcomings in the art.

In a simple form embodiments of the invention are directed to a system for detecting flaws in capsules. The system may include a capsule receiving plate having a top surface. The capsule receiving plate in accordance with one embodiment has a plurality of apertures. The apertures have a structure forming an opening in the top surface and a passageway that narrows to a location below the top surface. The passageway has a predetermined minimum dimension adapted to be slightly larger than a dimension of the capsules.

In one embodiment, the structure in the apertures includes at least one curve of intersection between at least two conical surfaces. In another embodiment, the structure includes a plurality of curves of intersection between respective adjacent conical surfaces.

In another simple form, embodiments of the invention are directed to an apparatus for flaw detection in capsules containing beneficial agents. In some embodiments, the apparatus includes a capsule receiving plate having a top surface and a plurality of apertures extending from the top surface through the plate. In one embodiment, the apertures have a structure that is generally tapered to form an opening in the plate at the top surface and a passageway that extends to a location below the top surface. The passageway has a smaller dimension than a dimension of the opening. The passageway has a predetermined minimum dimension adapted to be slightly larger than a dimension of the capsules. In another embodiment, in a cross-section of the apertures, the structure further includes at least one contact point formed by an intersection of two planar regions. In this embodiment, each planar region has a distinct angle.

A method of the present invention is also presented for detecting flaws in capsules and/or separate capsules having flaws from unflawed capsules. The method in the disclosed embodiments substantially includes the steps necessary to carry out the functions presented above with respect to the operation of the described apparatus and system.

Embodiments of a method of separating flawed capsules from unflawed capsules include supplying a plurality of capsules to an apertured plate. Embodiments of the method also include causing unflawed capsules from the plurality of capsules to pass through apertures, and inhibiting flawed capsules from the plurality of capsules from passing through the apertures. One embodiment of the method includes causing a rotation of the capsules by a structure within the aperture. Another embodiment of the method include causing capsules that have been inhibited from passing through the plate to move upward toward the top surface, and causing the capsules that have been inhibited to return to passageways in the apertures for at least one repeated attempt of passing the capsules through the plate.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIGS. 1a and 1b are perspective views illustrating capsules that are manipulated by the apparatus, system, or method of the present invention;

FIG. 2 is a perspective view of a system for detecting flawed capsules in accordance with an embodiment of the present invention;

FIG. 3 is a detailed perspective view of a portion of the system of FIG. 1;

FIG. 4 is a sectional view taken along line VI-VI of FIG. 3;

FIG. 5 is a detailed perspective view of another portion of the system of FIG. 1;

FIG. 6 is a detailed perspective view of another portion of the system of FIG. 1;

FIG. 7 is a bottom perspective view of another portion of the system of FIG. 1;

FIG. 8 is a perspective view of a system for detecting flawed capsules in accordance with another embodiment of the present invention; and

FIG. 9 is a schematic block diagram illustrating one embodiment of a method in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are set forth to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

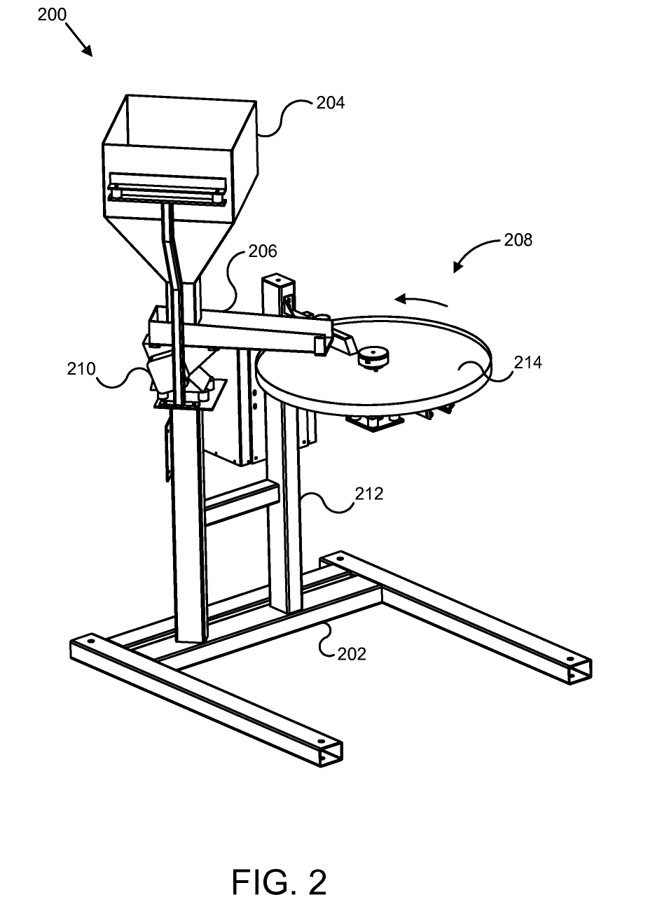

FIG. 2 is a perspective view diagram illustrating one embodiment of a system 200 for detecting and removing flawed capsules in accordance with the present invention. In one embodiment, the system 200 comprises a base 202 configured to support a hopper 204, a chute 206, and a plate 208. The hopper 204 is configured to receive a plurality of capsules 100. The chute 206 may be disposed below an opening of the hopper 204 in order to capture the capsules 100.

In a further embodiment, the chute 206 comprises an agitator 210 coupled with the chute 206 and configured to vibrate the chute 206 in such a manner that capsules proceed to travel down the chute 206 and onto the plate 208. The agitator 210 may be configured with an adjustable vibration frequency in order to accommodate different sized capsules.

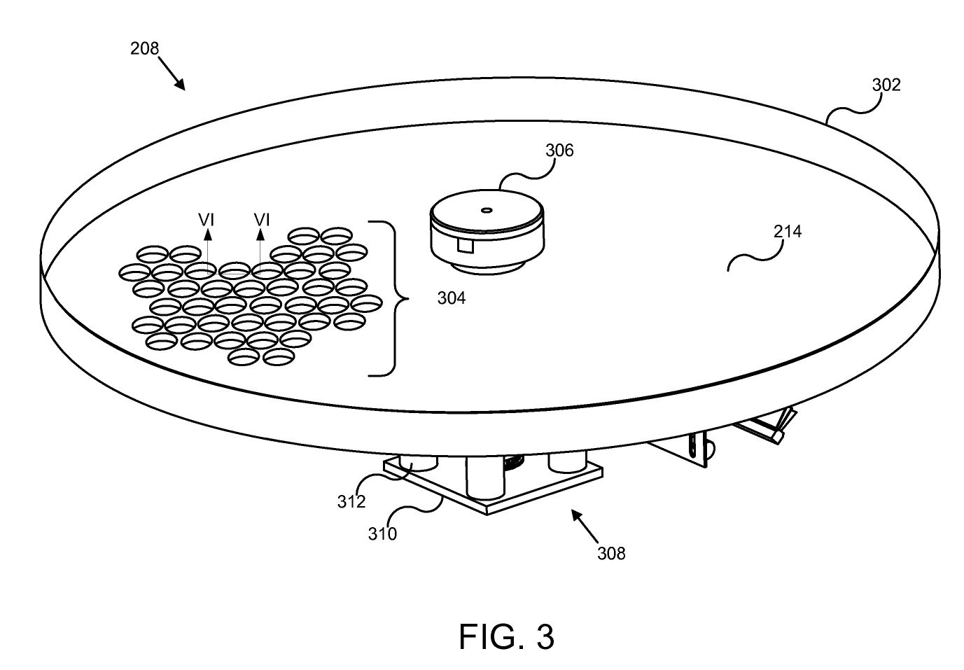

In the depicted embodiment, the plate 208 is coupled with an arm 212 of the base 202 such that capsules sliding down the chute 206 land on a top surface 214 of the plate 208. The plate 208 may be substantially circular and configured to rotate (as indicated by arrow 216). The plate 208 will be described in greater detail below with reference to FIG. 3.

FIG. 3 is a perspective view diagram illustrating one embodiment of the plate 208 in accordance with the present invention. In one embodiment, the plate 208 comprises a lip 302 extending upward from the top surface 214 of the plate 208. The lip 302 may be located at a perimeter of the plate 208 and be configured to retain capsules as the plate 208 rotates. In one embodiment, the plate 208 is configured to rotate at about 1-3 RPM.

The plate 208, in a further embodiment, is configured with a plurality of apertures 304 arranged in a manner to maximize the amount of apertures 304 that will fit on the top surface 214 of the plate 208. The depicted embodiment illustrates only a portion of the plate 208 having apertures, however, it is contemplated that the entire top surface 214 of the plate 208 may be covered with apertures 304.

In one embodiment, the plate 208 is coupled with a spindle 306 driven by a motor 308. Additionally, the motor 308 comprises an agitating device in order to vibrate the plate 208. The motor 308 may be mounted to a plate 310. The motor 308 may be mounted using rubber feet 312 or any suitable mounting device. The plate 310, in turn, is coupled with the base 202 of FIG. 2.

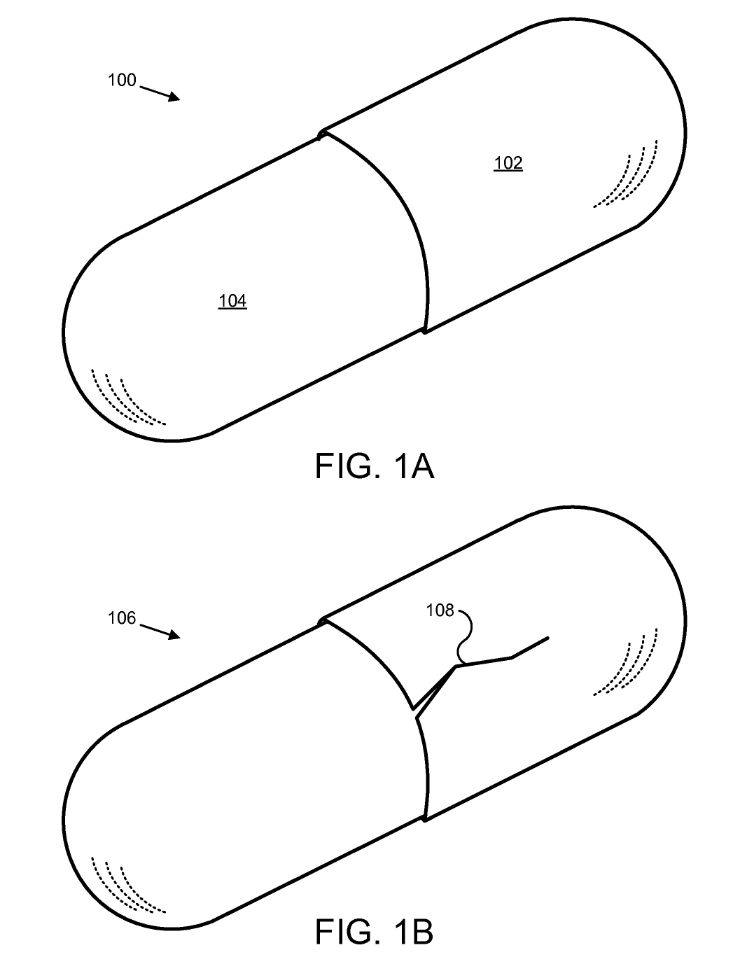

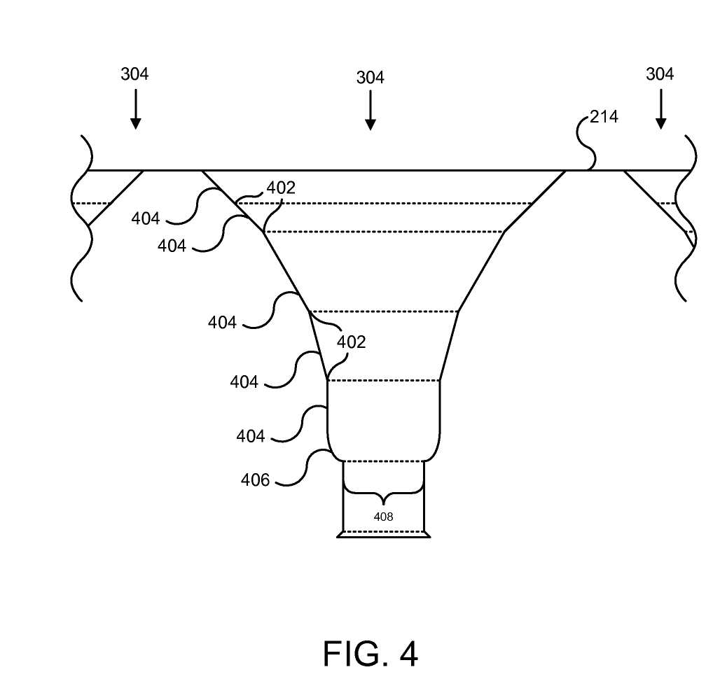

FIG. 4 is a cross-section diagram illustrating one embodiment of the apertures 304 in accordance with the present invention. The sectional view of FIG. 4 generally corresponds with a section taken along line VI-VI of FIG. 3 as viewed in a direction parallel to a plane of the plate 208. Each aperture 304 may comprise a plurality of contact points 402. The contact points 402 are formed from the intersection of any two planar or conical regions 404. In reality, that which appears to be planar or linear in the sectional view of FIG. 4 is a ray of a surface forming a cone, in which the ray is in the plane of the section. The conical regions 404 may be described as the frustum of conical shapes of differing angles, where the angles are relative to a central axis for example. The aspects of the drawing of FIG. 4 that appears to form the contact points 402 and the conical regions 404 are really curves of intersection and conical surfaces, respectively. Dimensions of spacings between these contact points 402 or dimensions of these curves of intersection are selected to allow capsules 100 (of FIG. 1a) to pass through the apertures 304 without bridging the dimensions. “Bridging” occurs when a capsule begins to pass through the aperture 304 but sticks and forms a bridge with one end of the capsule in the aperture 304 and the other end extending outward at an angle. The geometry of the angles of the intersection of the differing conical regions 404 and the corresponding contact points 402 promote consistent pass through of capsules 100. In one embodiment, the curves of intersection are round or circular. In other embodiments, the curves of intersection may be oval or rectangular.

Contact with the sharp contact points 402 which form the intersection of any two conical regions 404 also serve to influence the capsules to spin about their long axis in a manner such as in a coreolis effect. This spinning encourages or helps to ensure that the capsules do not bridge in any aperture. Normally, this capsule spinning causes sufficient capsule agitation along with a vibration of the disc itself to influence the capsule to pass through the aperture if indeed there is no damage to the capsule. On the other hand, when a capsule 100 is damaged, its outer dimension or diameter is usually modified and may not be conducive to passing through the aperture. In fact, with capsules that normally have round sections, damage typically deforms at least a portion of the capsule 100 to an out of round condition such that the capsule will not pass through a properly sized aperture that is round.

Other configurations for the apertures 304 are also possible within the scope of the present invention. For example, instead of a sharp contact points at 402, the contact points may be provided by rounded surfaces (not shown) that are also generally curves of intersection between and adjoining adjacent conical surfaces. Because of the relative angles of the conical surfaces, the rounded surfaces form raised portions or protrusions between the conical surfaces that may act similarly to the sharp contact surfaces 402 shown in FIG. 4. In another embodiment, the apertures 304 may have a continuous surface that does not have conical surfaces in a strict sense. To engage the capsules at particular diameters, annular ribs or raised portions may be placed at predetermined depths in the apertures. These annular ribs may engage the capsules to cause a coreolis effect or rotation about their long axes similar to that caused by the sharp contact points 402. Such annular ribs may be provided with predetermined inner diameters and may be placed in apertures that have generally funnel configurations. The apertures that have generally funnel configurations may have portions other than at the annular ribs that have any of a variety of shapes, which may or may not be conical. In one embodiment, the apertures may have a funnel configuration that is not strictly conical, but which may have a non-linearly changing radius along a length of the aperture. Even with a smooth funnel shape, a coreolis spinning effect may be caused, as described with regard to the annular ribs or sharp points above.

While the drawing figures and descriptions herein are directed to the example of capsules 202 that are oblong with round cross sections, the principles described herein may be applied to capsules having other configurations or to other forms of beneficial agent encapsulation including gel caps, tablets, caplets and pills in general, whether coated or un-coated. For example, with capsules or pills that are oblong with a non-round cross section, the sizing of apertures may still be applied even though the capsules or pills are not spun around their long axes during use of the apparatus. This may also be the case for tablets or gel caps that have saucer or button configurations. On the other hand, the size and shape of the apertures may be provided to capture tablets or gel caps having non-uniform surfaces or that do not conform to a predetermined size and shape. The apertures or associated structure on the top surface 214 may be provided to cause rolling of the tablets or gel caps for a more thorough check for flaws. Additional principles and teachings set forth below may also be similarly applied to capsules or pills having configurations other than those shown in the exemplary drawings.

In one example, referring back to the embodiment of FIG. 4, the angles of the conical regions from the uppermost (nearest the top surface 214) to the lowermost relative to the top surface 214 are 20°, 60°, 90°, and 120°, respectively. The depicted embodiment illustrates 6 distinct regions, however it is anticipated that any number of regions may be implemented. Likewise, the specific angles above are given by way of example only.

The apertures 304 may also be configured with curved regions 406 having a radius configured to receive one end of the capsule. The curved regions 406 enable the capsule to be oriented in a substantially vertical position before passing through the aperture 304. The intersection of the curved region 406 and a lower region 408 form an edge which serves to prevent the passage of a damaged capsule into the diameter of portion 408. The diameter of the lower portion 408 is selected according to the diameter of the capsules 100. In a broad range, a clearance between the capsules and the minimum diameter of the aperture may be provided by selecting the minimum diameter to be in a range from 0.0005 to 0.01 inch larger than the standard size of a capsule. In another range the minimum diameter of the apertures is in a range from 0.005 to 0.007 inch larger than the capsule. In one case, the minimum diameter is 0.006 inch larger than the capsule diameter. The diameter may be any size within these ranges. In a specific example, for processing size 0 capsules, which have a size of approximately 0.301 inch, three plates may be formed including apertures having minimum diameters or 0.307, 0.3075, and 0.308, respectively. These aperture sizes may thus be used to detect flaws in capsules with a variety of beneficial agents or for a different standard of detection. In one example, the diameter of the lower portion 408 is about 0.004 inch larger than the diameter of the capsule.

The diameter of the lower portion 408 is selected such that any capsule with a flaw will not pass through the aperture 304. Because the majority of critical flaws will affect the diameter of the capsule, only those capsules with no flaws influencing the diameter of the capsule pass through the lower portion 408 of the aperture 304. Flaws may be manifest by a bulge or tear that causes a material of the capsule to extend outside the normal radius of the capsule. However, flaws may also be manifest by capsules that are not straight along their longitudinal axes. Typically, out of straight capsules are not straight due to a flaw. These out of straight capsules can be detected by apertures 304 having a progressively narrower diameter. For example, the out of straight characteristic is able to pass a first larger diameter, but cannot pass a second narrower diameter at a deeper or lower position in the aperture structure. In a specific example, a size 0 capsule having a 0.301 inch diameter may pass through a 0.307 inch diameter portion of the aperture even though it is not straight. However, providing a subsequent or lower portion of the aperture having a diameter of 0.3075 or 0.308 inch an out of straight capsule will be retained in the aperture 304. The upper portion may have a difference in a range from one to three thousandths inch greater than the diameter of the lower or subsequent portion.

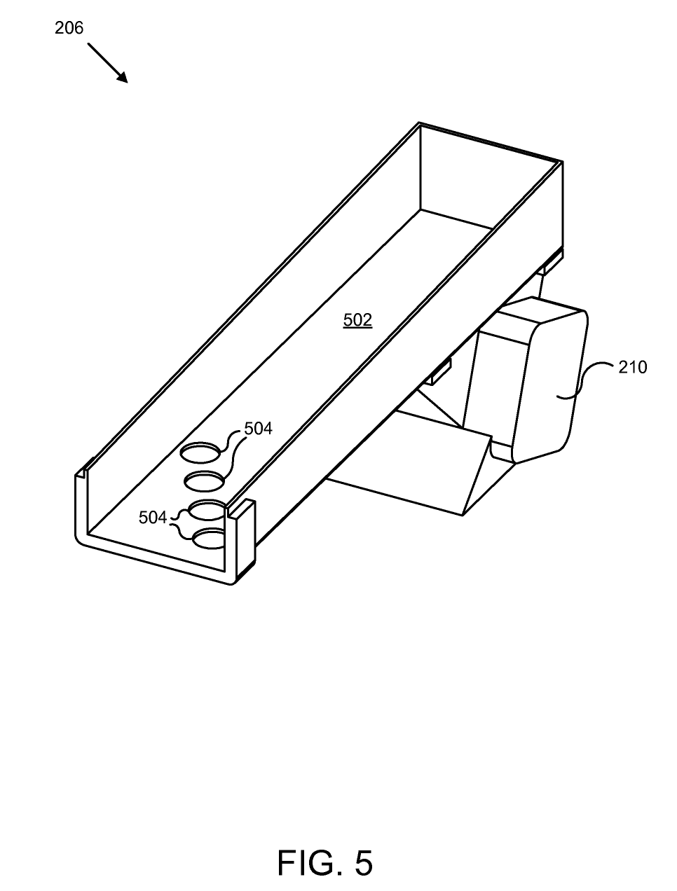

FIG. 5 is a perspective view diagram illustrating one embodiment of the chute 206 in accordance with the present invention. As described above with reference to FIG. 2, the chute 206 is configured to catch capsules from the hopper 204. The chute 206 may include an elongated channel 502 having a plurality of openings 504. The openings 504 are configured to distribute capsules across the top surface of the plate.

In one embodiment, the openings are arranged to distribute or deposit more capsules closer to the lip of the plate than towards the spindle. This is due to the greater number of apertures 304 in the region around the perimeter of the plate than towards the center of the plate.

The agitator 210, in one embodiment, is coupled with the chute 206 and is configured to vibrate the chute 206 and in turn cause the capsules to travel towards the openings 504. The agitator 210 is configured with an adjustable frequency in order to speed or slow the speed of the capsules.

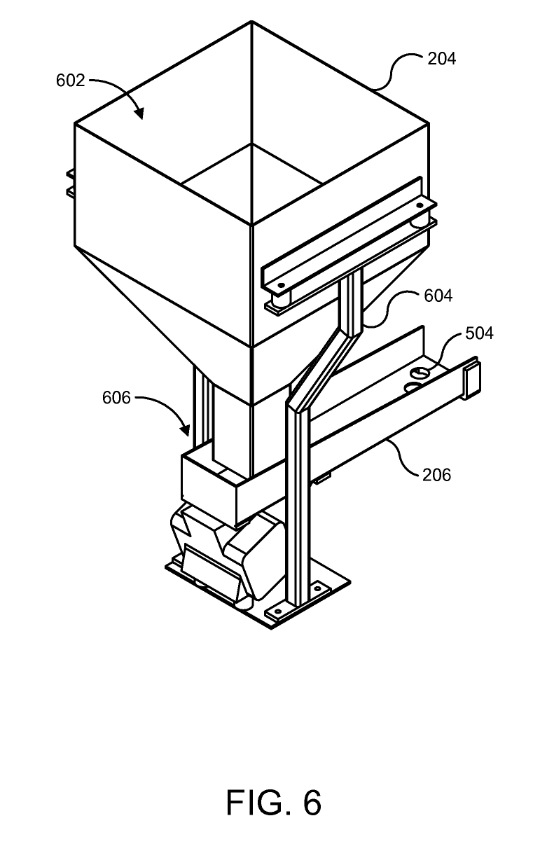

FIG. 6 is a perspective view diagram illustrating one embodiment of the hopper 204 and the chute 206 in accordance with the present invention. The hopper 204 is configured with an opening 602 for receiving large quantities of capsules. The capsules may be poured in manually, or deposited by way of conveyor belt (not shown), for example. The hopper 204 may be supported by a frame 604 as depicted.

In one embodiment, the chute 206 is disposed directly below the hopper 204 such that the capsules are deposited into an upper end 606 of the chute 206. Both the hopper 204 and the chute 206 may be formed substantially of the same material or alternatively of different materials.

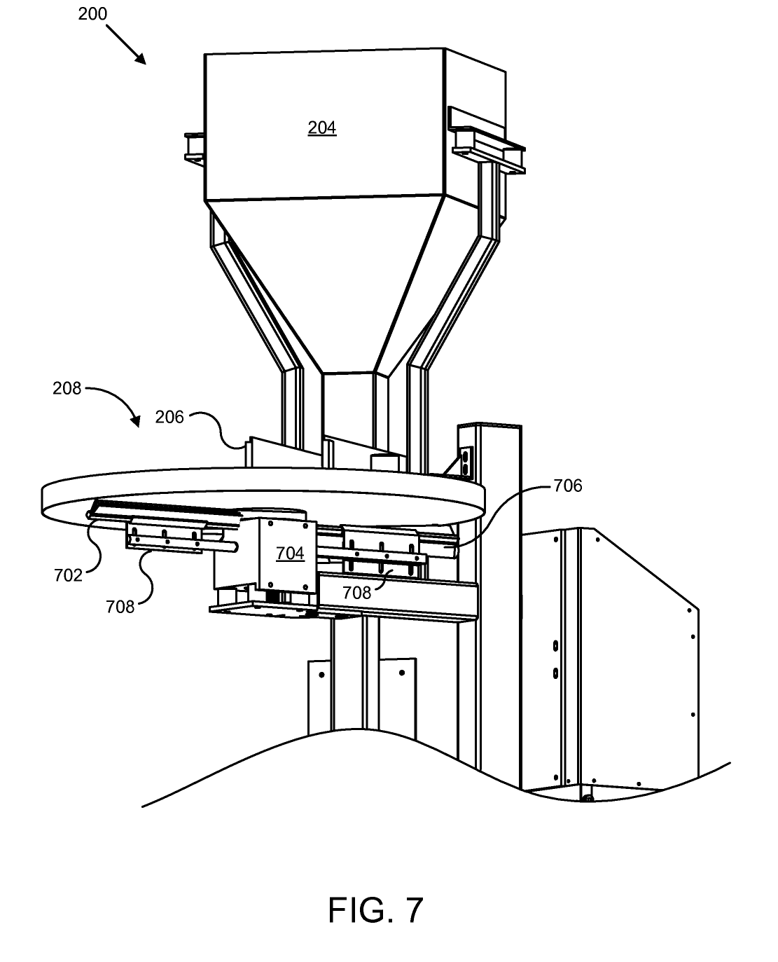

FIG. 7 is perspective view diagram illustrating one embodiment of the system 200 in accordance with the present invention. In one embodiment, the system 200 includes an inclined plane element 702 coupled with the motor housing 704. The plane element 702 is configured to approach the underside of the plate 208 at an inclined angle. Flawed capsules that have become lodged in the apertures 304 will be “popped-up” by an inclined planar surface of the plane element 702 for the purpose of causing capsules to re-try to pass hole portion 308 at least one additional time. A second attempt to pass through the aperture 304 is allowed because capsules may initially be held from passing through hole portion 308 due to a small piece of matter such as a granule of medicine. The plane element 702 may include solid squeegee style blades, a gradually inclined plane of any material, or individual stranded brushes, and may be accompanied with a cleaning air blast or other motive force to agitate the capsule and urge it up and out of the apertures 304 in order to be retried in a second or subsequent attempted pass through the aperture 308.

In a further embodiment, a blower 706 is also coupled with the motor housing 704. The blower 706 is configured to propel flawed capsules upward to be captured by a vacuum system. The blower 706, in an alternative embodiment, may include a second inclined plane element similar to the plane element 702. The second inclined plane element may include a plenum which distributes air upward on a capsule as the capsule passes over the highest edge. Both the plane 702 and the blower 706 are connected to adjustable mounts 708 and may be raised or lowered depending upon the size of the capsules.

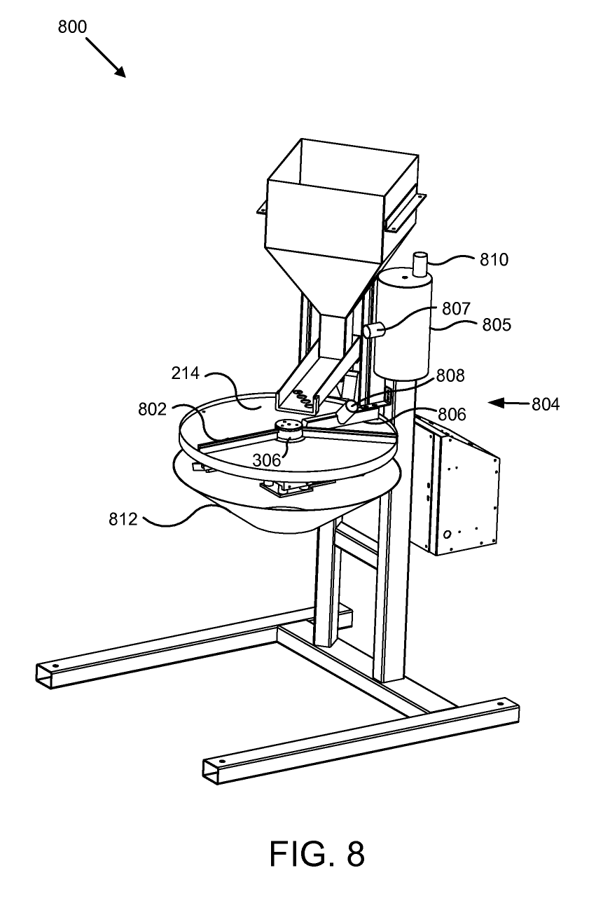

FIG. 8 is a perspective view diagram illustrating another embodiment of a system 800 in accordance with the present invention. The system 800, in one embodiment, includes at least one brush 802 coupled with the spindle 306. The brush 802 extends outward from the spindle 306 and may float above the top surface of the plate 208 a predetermined distance. The brush 802 is configured to inhibit more than one capsule from attempting to pass through one aperture 304 at a time. This is accomplished by knocking over any double stacked capsules. For this purpose, a predetermined distance is selected for placement of the brush 802 above the top surface 214 according to the size of the capsules.

The system 800 also includes a vacuum system 804 for removing the capsules from the plate 208 and depositing them in a collection canister or container 805. In one embodiment, a vacuum head 806 is coupled with the frame. An outlet 808 may be integrally formed in the vacuum head 806 and configured to interface with a vacuum hose (not shown). The vacuum hose connects the vacuum head 806 to the collection container 805 at an inlet port 807. The vacuum hose is not illustrated here for clarity. However, many different types of hoses may be used to fluidly couple the vacuum head 806 with the container 805.

Capsules which have been collected by the vacuum head 806 are induced to flow through the vacuum hose by means of sufficient vacuum flow velocity, and are deposited into the collection container 805 in which the velocity of the vacuum air is slowed due to the enlargement of the volume or cross sectional area of the container 805 in comparison to that of the vacuum hose. A vacuum or a lower pressure is maintained within the container 805, and at the top of the container 805 air is induced to flow through a smaller hole 810 leading to the vacuum source. The full capsules naturally sink to the bottom of the container 805 due to their mass, and capsules which may be empty are constrained to remain in the vessel due to a perforated wall (not shown) that separates the container 805 from the outlet of the smaller hole 810 at the top of the vacuum container 805, thereby preventing their escape.

The system 800, in a further embodiment, comprises a shroud 812 mounted to the underside of the plate in order to direct capsules into a tub, barrel, bucket, or other collecting container (not shown). Capsules that are not flawed pass through the apertures in the plate and are directed by the shroud 812 into the collecting container.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

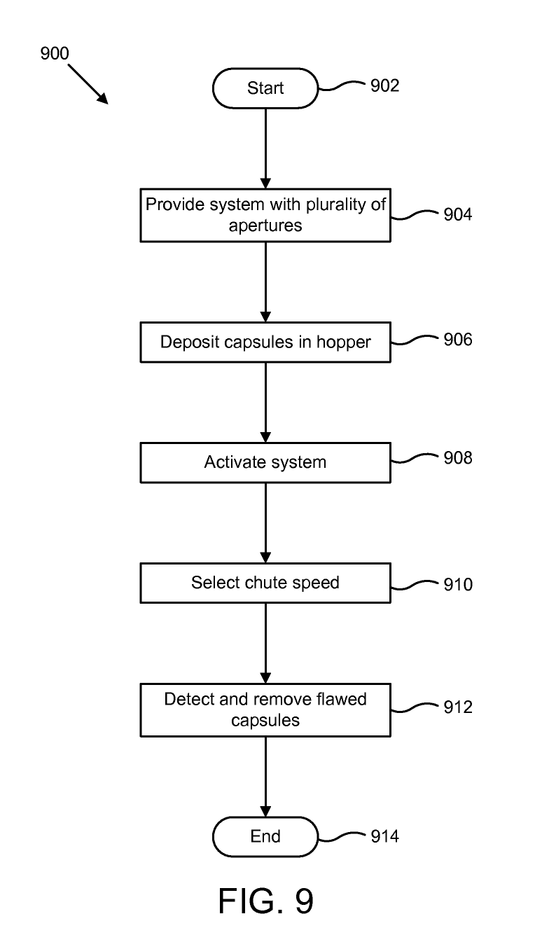

FIG. 9 is a schematic flow chart diagram illustrating a method 900 of detecting and removing flawed capsules in accordance with the present invention. The method 900 starts 902 and a system 200/800 is provided with a plurality of apertures 304 in accordance with the embodiment of FIGS. 2-8. The apertures 304 may be configured in a manner similar to that of FIG. 4.

The method 900 continues and capsules may be manually deposited into the hopper. Alternatively, capsules may be deposited in any number of automated manners such as by conveyor belt. The system is then activated 908 by an operator. The operator may be a person or alternatively a computer control system in electronic communication with the system 200/800. The operator then selects 910 the chute speed and the capsules are deposited on the plate for detection and removal 912 of flawed capsules. The method 900 then ends 914.

Although the encapsulated beneficial agent is shown and described by way of example herein as being contained in a two part capsule, it is to be understood that the beneficial agent may be encapsulated in any form that is generally known and referred to as a pill. Pills take a variety of forms including capsules, tablets, gel caps, and caplets, for example. Thus, reference to a pill or pills herein is to be taken to include any and all of the specific forms of pills that are known including capsules. The system, as referred to herein, may include an apparatus or a plurality of apparatuses that are associated with each other and which function together. A system is generally more comprehensive than an apparatus. For example, an apparatus may include the plate for receiving capsules whereas the system may further include a motor for moving the plate.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for detecting flaws in capsules, comprising:
a capsule receiving plate having a top surface, the capsule receiving plate having plurality of apertures; wherein:
the apertures have a structure forming an opening in the top surface and a passageway that narrows to a location below the top surface; and
the passageway has a predetermined minimum dimension adapted to be slightly larger than a dimension of the capsules.

2. The system of claim 1, wherein the structure comprises at least one curve of intersection between at least two conical surfaces.

3. The system of claim 2, wherein the structure comprises a plurality of curves of intersection between respective adjacent conical surfaces.

4. The system of claim 1, further comprising:
a supply chute for conveying the capsules to the plate; and
at least one mechanism in the system for aiding distribution of the capsules by the chute on the plate.

5. The system of claim 4, wherein the at least one mechanism comprises an agitator coupled to the chute, the agitator having an adjustable frequency of agitation.

6. The system of claim 4, wherein the at least one mechanism comprises a plurality of openings in the chute for passing the capsules through the chute at a plurality of locations on the plate.

7. The system of claim 1, further comprising at least one mechanism for moving the capsules when they become lodged in the apertures, wherein the mechanism comprises at least one of a brush, an inclined plane element, and a gas plenum positioned on the system to engage the capsules when they become lodged.

8. The system of claim 7, wherein the mechanism is height adjustable relative to the plate.

9. The system of claim 1, further comprising a vacuum in the system and having a vacuum head in proximity to the plate for removing the flawed capsules.

10. The system of claim 1, further comprising a motor coupled to the plate for rotating the plate, the motor also coupled to at least one brush disposed at a predetermined height above the plate.

11. An apparatus for flaw detection in capsules containing beneficial agents, comprising:
a capsule receiving plate having a top surface and a plurality of apertures extending from the top surface through the plate; wherein:
the apertures have a structure that is generally tapered to form an opening in the plate at the top surface and a passageway that extends to a location below the top surface;
the passageway has a smaller dimension than a dimension of the opening; and
the passageway has a predetermined minimum dimension adapted to be slightly larger than a dimension of the capsules.

12. The apparatus of claim 11 wherein the structure further comprises:
in a cross-section of the apertures, at least one contact point formed by an intersection of two planar regions, each planar region having a distinct angle.

13. A method of separating flawed capsules from unflawed capsules, the method comprising:
supplying a plurality of capsules to an apertured plate;
causing unflawed capsules from the plurality of capsules to pass through apertures; and
inhibiting flawed capsules from the plurality of capsules from passing through the apertures.

14. The method of claim 13, further comprising providing a clearance between the unflawed capsules and the passageway of approximately 0.004 inch.

15. The method of claim 13, further comprising causing a rotation of the capsules by a structure within the apertures.

16. The method of claim 13, further comprising:
causing capsules that have been inhibited from passing through the plate to move upward toward the top surface; and
causing the capsules that have been inhibited to return to passageways in the apertures for at least one repeated attempt of passing the capsules through the plate.

17. The method of claim 16, wherein causing the capsules to move upward comprises directing a flow of gas.

18. The method of claim 16, wherein causing the capsules to move upward comprises engaging the capsules with an inclined plane element.

19. The method of claim 13, further comprising removing the flawed capsules from the plate by a vacuum.

20. The method of claim 19, further comprising separating the flawed capsules from a flow of air in the vacuum by:
slowing the flow of air in a canister; and
enabling the capsules to fall to a bottom of the canister under the influence of gravity.
